(19) United States
(12) Patent Application Publication
(10) Pub. No.: US 2018/0099786 A1
(43) Pub. Date: Apr. 12, 2018

(54) Reclosable Label

(71) Applicant: Gateway Packaging Company, Granite City, IL (US)

(72) Inventors: Omar Abuaita, Waxhaw, NC (US); Kevin Lemmons, Jackson, MO (US); Brian Schiermeier, Florissant, MO (US)

(21) Appl. No.: 15/473,586

(22) Filed: Mar. 29, 2017

Related U.S. Application Data
(63) Continuation-in-part of application No. 15/288,300, filed on Oct. 7, 2016.

(51) Int. Cl. B65D 33/16; B65D 77/32; B65D 33/34; B31B 70/14; B31B 70/16; B31B 70/81

(52) U.S. Cl. CPC B65D 33/1691; B65D 77/32; B65D 33/34; B31B 2170/20; B31B 70/146; B31B 70/16; B31B 70/813; B31B 70/142

(57) ABSTRACT

A resealable label is disclosed, the label having a top layer and a bottom layer. The top layer may be one or more ply, and the bottom layer may be one or more ply. The top layer is adhered to the bottom layer via an adhesive layer there-between. The bottom layer includes a concave perforation, the concave perforation having a line defined by endpoints of the concave perforation. The label further includes a layer of deadener between the label layers, the deadener being on the convex side of the perforation, and terminating at the line, the line extending to opposing edges of the label, where the deadener is at least some distance away from the perforation such that the deadener and the perforation do not abut. The label may further have a layer of adhesive on the bottom layer for adhering the label to a surface. The disclosure further includes a reclosure system that includes the resealable label and an inner label for mounting on a surface. A method of assembling a resealable label to a panel of bag material is additionally disclosed, the method including cutting of the panel to create a series of perforations and gaps there-between.

### PRIORITY CLAIM

This application is a continuation-in-part of of and claims priority to co-pending U.S. patent application Ser. No. 15/288,300, filed on Oct. 7, 2016, which was a continuation of and claimed priority to U.S. patent application Ser. No. 14/630,293, now issued as U.S. Pat. No. 9,475,615 B2, and filed on Feb. 24, 2015. Those documents are hereby incorporated herein by reference in their entirety.

### FIELD OF THE DISCLOSURE

An apparatus and system for resealing bags is disclosed, specifically a multi-layered label that may be adhered to the exterior of a bag and allow for ready resealable access to the contents therein. A method of assembling a resealable label onto a panel of bag material is also disclosed.

### BACKGROUND

The statements in this section merely provide background information related to the disclosure and do not necessarily constitute prior art.

Many types of food products are packaged and sold to consumers in some form of bag, including multi-layered bags that contain at least one kraft paper layer. Grease or other oils or elements in some food products, particularly pet foods, may break down kraft paper. This breakdown can result in an obviously undesirable loss of bag integrity and/or failure of the bag.

Resealability of food product bags is a desirable feature, as air can cause spoilage of the food product(s) contained therein. Many types of resealable mechanisms exist, including plastic zipper strips that mate to form a resealable closure. These zipper strips can be expensive and add significant additional manufacturing steps.

There exists a need in the art for a new resealable mechanism that can be used on bags, including those that contain at least one paper layer.

### SUMMARY

This section provides a general summary of the disclosure, and is not intended to provide a comprehensive disclosure of its full scope or all of its features.

A system for creating a resealable seal on a bag is disclosed. More specifically, a label is disclosed that may be adhered to the exterior of a bag, including a multi-layered bag containing at least one paper layer, where the label includes a resealable aperture. This label may be used in conjunction with a second interior label, and a perforation of the bag to create a unique resealable mechanism, one that prevents the interior food product from making contact with any paper layer of a multi-layered bag upon which it has been installed. A method of applying this system and label is disclosed.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

The drawings described herein are for illustrative purposes only of selected embodiments and not all possible implementations, and are not intended to limit the scope of the present disclosure.

FIG. 1 shows a perspective view of a portion of a panel of a bag wall, the panel having an embodiment of a resealable label adhered thereto, the label pulled back in an open position to grant access to the inside of the bag.

FIG. 2 shows a top view of an embodiment of a resealable label, this embodiment including a tamper evident feature.

FIG. 3 shows regions of adhesive and deadener between the layers of the embodiment of a resealable label of FIG. 2.

FIG. 4 shows regions of adhesive and deadener between the layers of an embodiment of a resealable label, this embodiment not including a tamper evident feature.

FIG. 5 shows a top view of an embodiment of an inner label, for use in conjunction with a resealable label in some applications.

FIG. 6 shows the embodiment of the inner label of FIG. 5, with additional details showing regions of adhesive and deadener.

FIG. 7 shows the cross-sectional view along line A-A of FIG. 2, where both a resealable label and an inner label have been adhered to a panel of a bag wall.

FIG. 8 shows the cross-sectional view along line A-A of FIG. 2, where a resealable label has been adhered to a panel of a bag wall.

FIG. 9 shows the cross-sectional view along line B-B of FIG. 1, where both a resealable label and an inner label have been adhered to a panel of a bag wall.

FIG. 10 shows the cross-sectional view along line B-B of FIG. 1, where a resealable label has been adhered to a panel of a bag wall.

FIG. 11 shows an exploded perspective view of an embodiment of a resealable label and its layers as applied to the exterior of a panel of a bag wall that has been perforated with a tombstone-shaped cut.

FIG. 12 shows an exploded perspective view of an embodiment of a resealable label and an inner label as applied to the exterior of a panel of a bag wall that has been perforated with a tombstone-shaped hole.

FIG. 13 shows an embodiment of a resealable label adhered to panel of a gusseted top-sealed bag wall, the label pulled back in an open position to grant access to the inside of the bag.

FIG. 14 shows an embodiment of the shape of the concave perforation of the resealable label, this shape being a V having a rounded bottom.

FIG. 15 shows another embodiment of the shape of the concave perforation of the resealable label, this shape being a rectangle having rounded corners.

FIG. 16 shows yet another embodiment of the shape of the concave portion of the resealable label.

FIG. 17 shows another embodiment of the shape of the concave portion of the resealable label, this shape being a semicircle.

FIG. 18 shows an exploded perspective view of an embodiment of the layers of a resealable label as applied to the exterior of a panel of a bag wall.

FIG. 19 shows an embodiment of the label of FIG. 18, assembled and at least partially opened.

FIG. 20 shows an embodiment of a portion of the perforation on the bag wall, with details on the relative positions of various elements of a tamper-evident feature.

FIG. 21 shows a view of an embodiment of a portion of woven oriented polypropylene and adjacent cuts thereon, as detail of an area seen in FIG. 20.

FIG. 22 shows a view of an embodiment of the resealable label of FIG. 19 affixed to a bag wall, having been opened for access thereinto.

FIG. 23 shows an elevated perspective view of an embodiment of a cutting die that may be used to generate the perforation pattern seen in FIG. 20.

FIG. 24 shows a side view of the cutting die seen in FIG. 23.

FIG. 25 shows a top down view of the cutting die seen in FIG. 23.

Corresponding reference numerals indicate corresponding parts throughout the several views of the drawings.

### DETAILED DESCRIPTION

The following description of various embodiments is merely exemplary in nature and is in no way intended to limit the invention, its application, or its uses. Areas of applicability will become apparent from the description provided herein.

A resealable label is disclosed, the label having a top layer and a bottom layer. The label has edges that make up a perimeter that define a shape of the label. The top layer may be one or more ply, and the bottom layer may be one or more ply. The top layer is adhered to the bottom layer via an adhesive layer there-between. The bottom layer includes a concave perforation, the concave perforation having a line defined by endpoints of the concave perforation, the line extending beyond the endpoints and terminating at edges of the label.

The label further includes a layer of deadener between the label layers, the deadener being on the convex side of the perforation, and terminating at the line, the line extending to opposing edges of the label, where the deadener is at least some distance away from the perforation such that the deadener and the perforation do not abut.

The label may further have a layer of adhesive on the bottom layer for adhering the label to a surface.

Turning to the figures, the features of the resealable label may be more clearly illustrated.

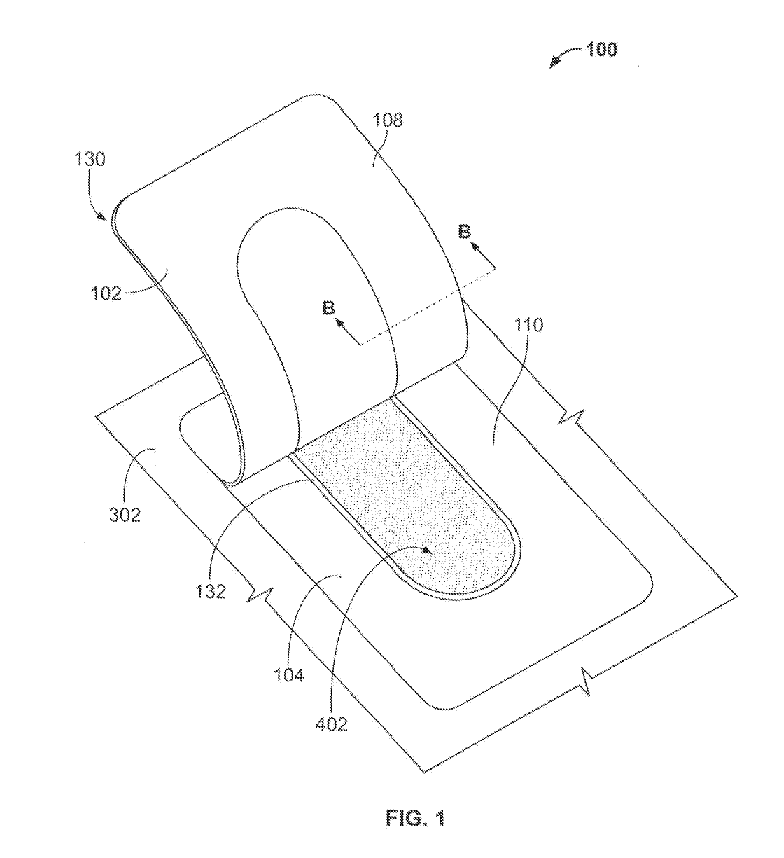

FIG. 1 shows a perspective view of a portion of a panel of a bag wall 302, the panel having an embodiment of a resealable label 100 adhered thereto, the label pulled back in an open position to grant access to the inside of the bag 402.

In the view of FIG. 1, the top layer 102 of the resealable layer has been opened and pulled back, revealing a portion of the bottom layer 104. The adhesive layer 108 between the top and bottom layers remains adhered to the exposed portion of the top layer, while the deadener 110 on the bottom layer prevents the adhesive from more permanently sticking the two label layers together, thereby permitting the resealable opening of the label as seen in FIG. 1. The reclosure region 132 of the label is also visible in FIG. 1, in an area where no deadener has been applied to the bottom layer 104, thereby providing a secure seal between the layers of the label. To open the label, one may pull on the corner 130 of the top layer of the resealable label.

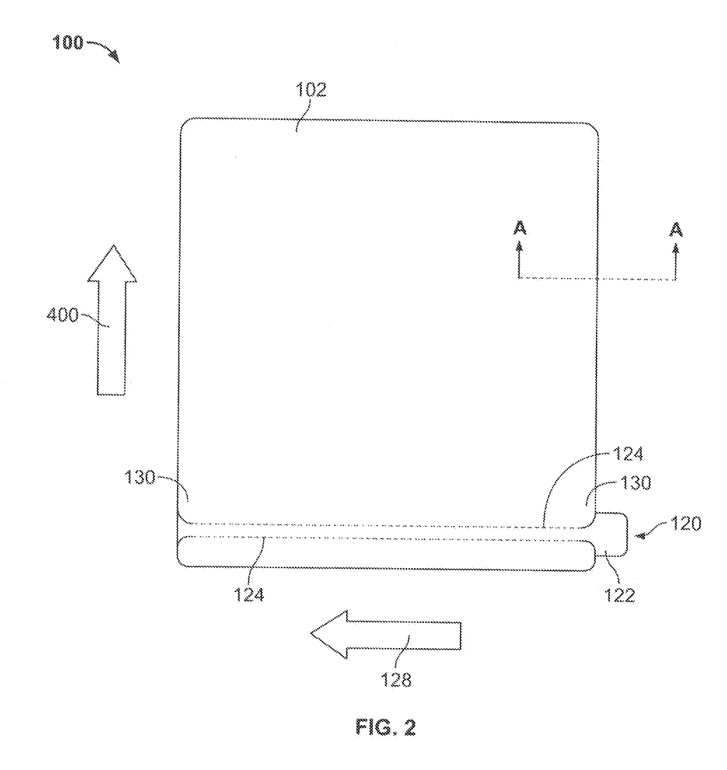

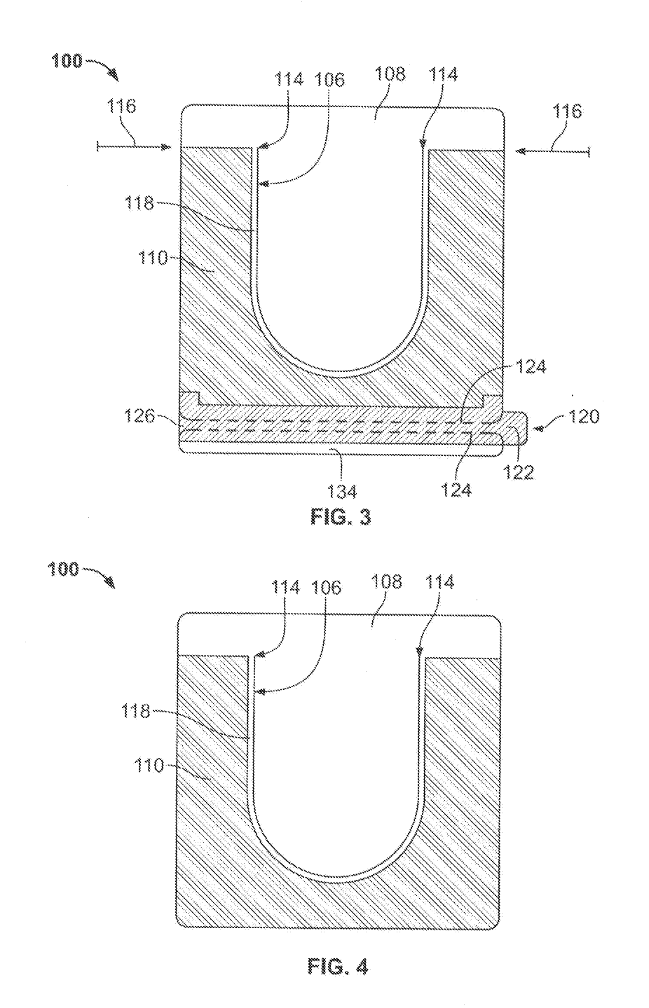

FIG. 2 shows a top view of an embodiment of a resealable label 100, this embodiment including a tamper evident feature 120. Any variety of appropriate tamper evident apparatus may be used with the disclosed resealable label, and this particular embodiment seen in the figures is non-limiting. In FIG. 2, only the top layer 102 is visible, obscuring the view of the bottom layer or the adhesive layer. FIGS. 2 and 3, viewed together, provide details on this particular embodiment of the tamper evident apparatus.

The embodiment of the tamper evident feature 120 seen in FIG. 2 includes a tab 122 and two linear substantially parallel series of incomplete perforations 124 of the top layer 102 of the label 100. The pull tab 122 is a protrusion of the top layer at an edge of the label generally centered at adjacent terminating ends of the series of perforations 124. In operation, a user of the label may grab a hold of the tab and pull it in a tamper evident applications opening direction 128. In so doing, the user will remove the portion of the top layer 102 between the two linear substantially parallel series of incomplete perforations 124. Once that portion of the top layer has been so removed, the user may then grab a hold of the corner of the resealable label 130 and pull the top layer back in an opening direction 400. The result of this series of steps is the image seen in FIG. 1 of an opened label that may be resealed.

FIG. 3 shows regions of adhesive 108 and deadener 110 between the layers of the embodiment of a resealable label 100 of FIG. 2, as well as the perforation 106 of the bottom layer. In this embodiment, the resealable layer has both a top layer and a bottom layer, as in FIG. 1. The perforation 106 is generally concave in shape and, as will be seen in subsequent figures, may be in a variety of shapes. The perforation 106 resides on the bottom layer of the label 100. In this embodiment, the perforation is in a U-shape. A line 116 may be imagined thereon having the two endpoints 114 of the perforation. This line 116 marks the furthest back that the top layer may be pulled to open the resealable label 100, as described in the preceding paragraph and as seen in FIG. 1, for example.

The region of deadener 110 between the labels can generally be defined as bound by the line 116, the outer edges of the label, the tamper evident apparatus 120, and the perforation 106, where some distance 118 exists between the perforation and the labels. Where the deadener 110 meets the tamper evident apparatus 120, the deadener between the layers may terminate at another abutting layer of deadener in the same plane that is a part of the tamper evident apparatus. Alternatively, the deadener layer 110 may be applied in concert with the tamper evident deadener region 126. In another embodiment, the tamper evident deadener region 126 may be applied in addition to the deadener layer 110 such that the tamper evident deadener region is actually a double application of deadener.

Referring to the tamper evident apparatus 120 as seen in FIG. 3, the series of perforations 124 are in this embodiment substantially parallel to the line 116 defined by endpoints 114 of the concave perforation 106. The series of perforations 124 reside a distance away from and on the same side as the convex end of the concave perforation 106. Beyond the tamper evident deadener region 126 is the tamper evident apparatus non-deadener region 134, which is essentially a layer of adhesive that keeps a portion of the top layer adhered to the bottom layer after the opening of the tamper evident apparatus 120.

The tamper evident deadener region 126 extends out to the tab 122 to ease in the lifting of the tab and tearing of the perforations 124 to open the label.

FIG. 4 is a similar view to that of FIG. 3, except that this particular label does not have a tamper evident apparatus. The regions of adhesive 108 and deadener 110 between the layers of an embodiment of a resealable label are seen in this embodiment, one not including a tamper evident feature. In this embodiment, the label 100 again has a concave U-shaped perforation 106, the perforation having two endpoints 114. The perforation resides some distance 118 from the edge of the deadener 110.

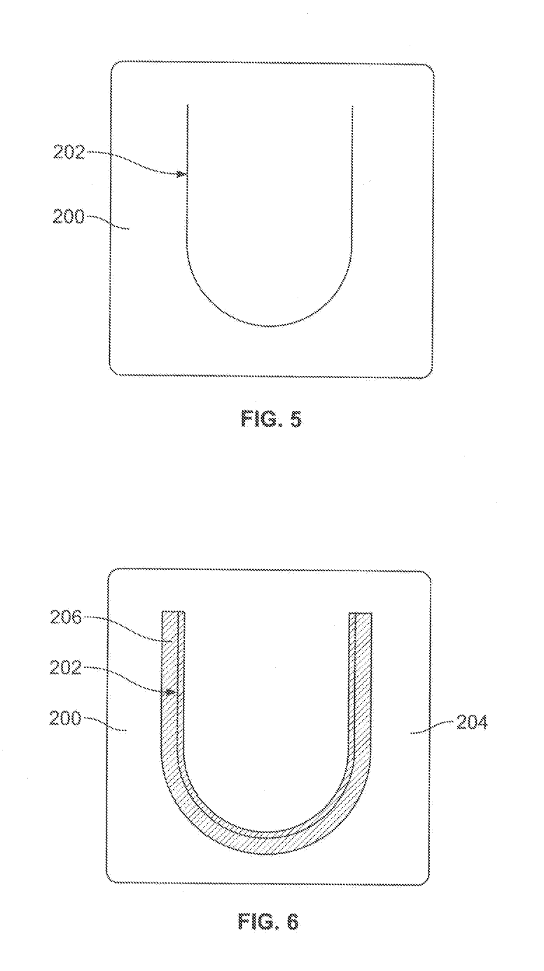

FIG. 5 shows a top view of an embodiment of an inner label 200, for use in conjunction with a resealable label in some applications. The inner label has a perforation 202 that is complementary in shape to the perforation of the bottom layer of the resealable label seen in the prior figures. Where an inner label is present, the perforations 106 and 202 should be complementary in shape, though not necessarily in the same dimensions, as will be seen in subsequent figures. The outer edges of the inner label 200 may be the same as that of the resealable label 100, though this is not required. In the figures, both the resealable label 100 and the inner label 200 are both a square with rounded edges.

FIG. 6 shows the embodiment of the inner label 200 of FIG. 5, with additional details showing regions of adhesive 204 and deadener 206, relative to the perforation of the inner label 202.

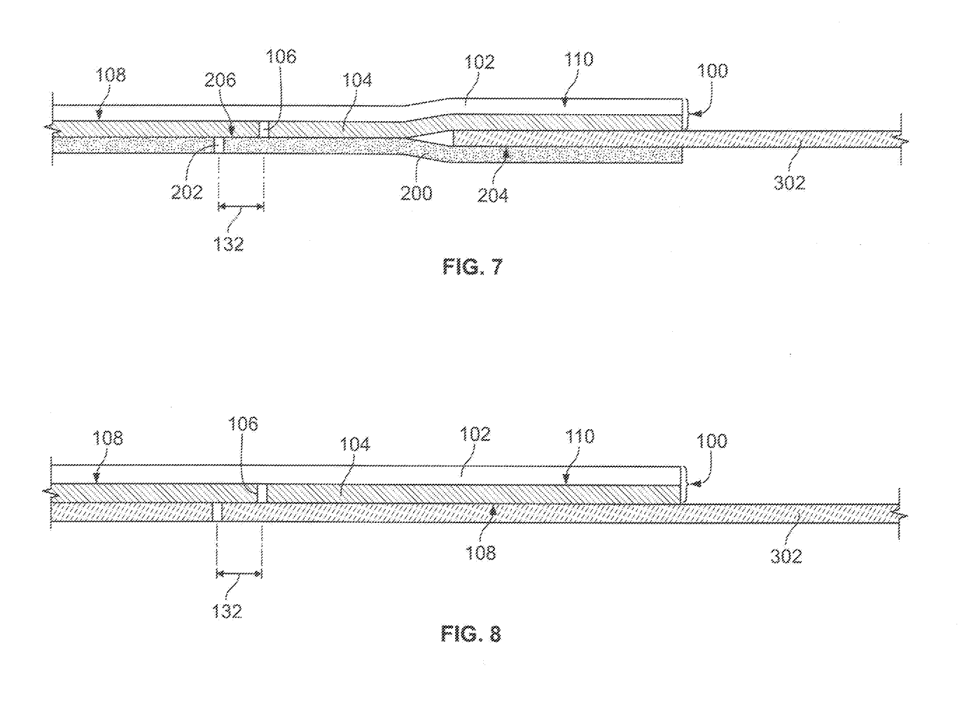

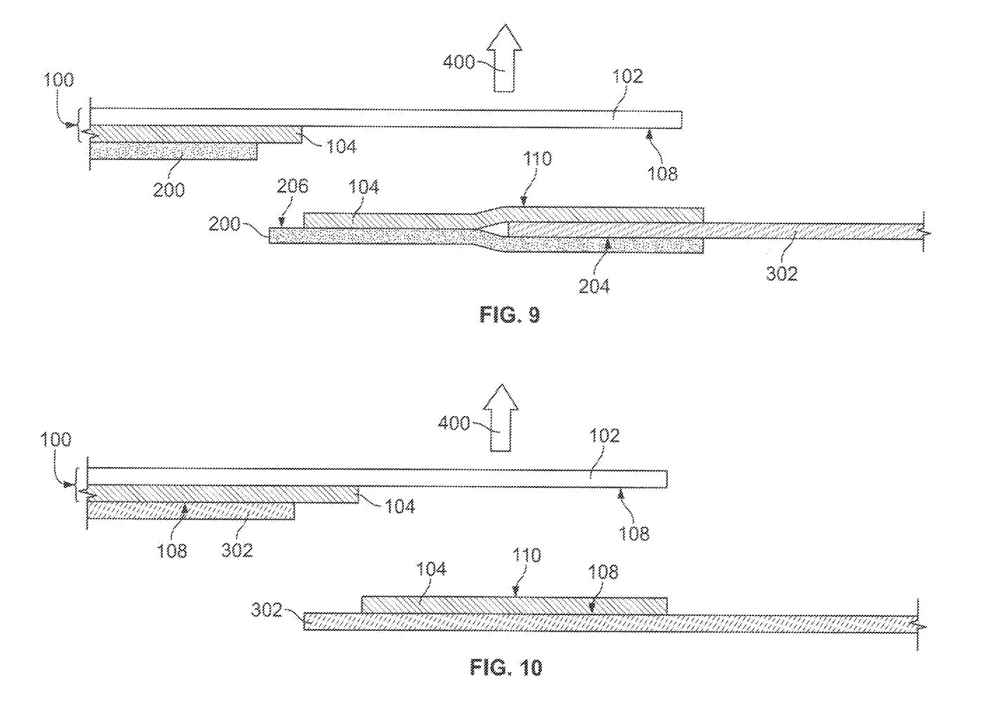

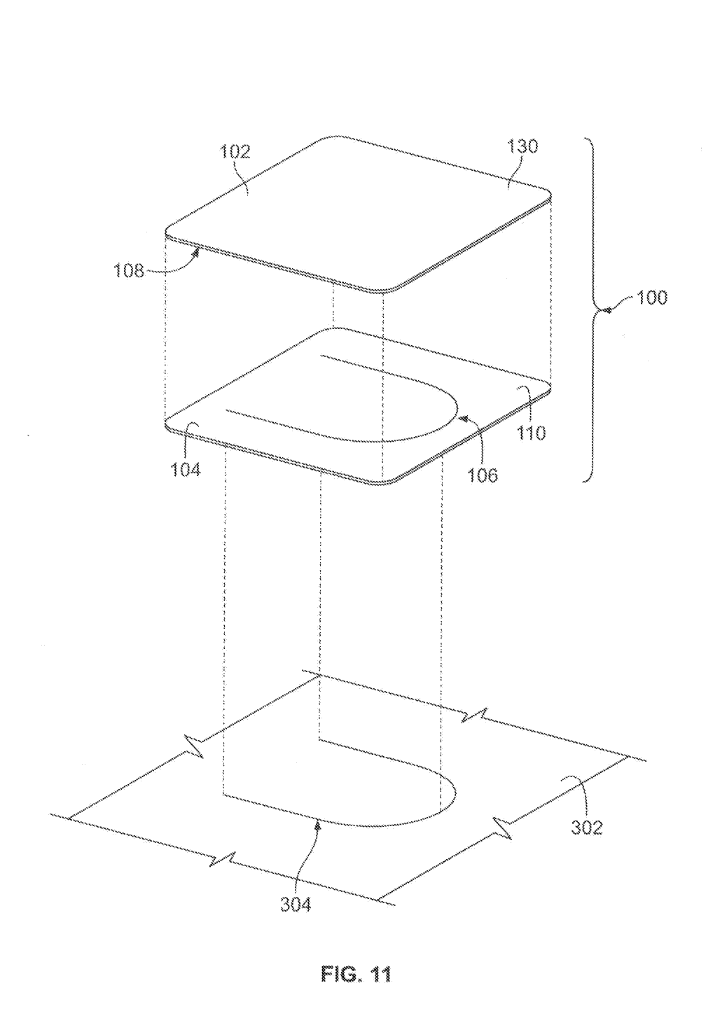

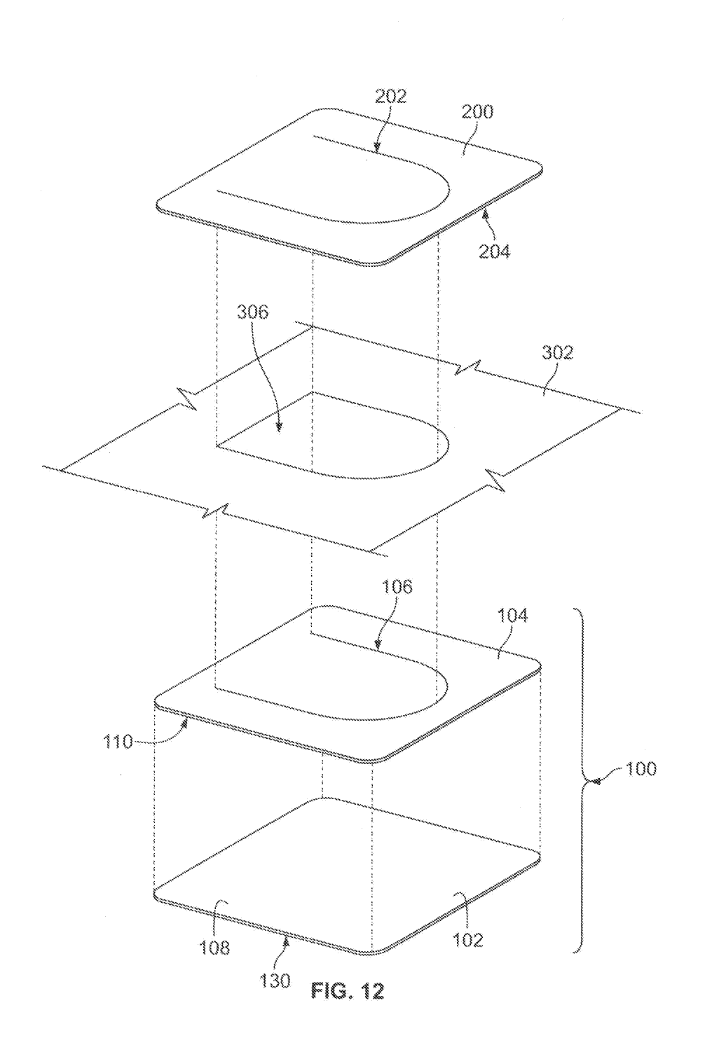

The label may be used in conjunction with a variety of containers, including bags. Among the types of bags for which the label may be used, both paper multi-layered and plastic bags are discussed herein. Where the resealable label is applied to a plastic bag, including single ply or multi-layered plastic bags, a perforation may be made in the wall of the bag such that the label adheres to a portion of the bag wall. Conversely, when the label is applied to a paper bag, including a multi-layered paper bag, an opening may be made in the bag wall complementary to the perforations of the resealable label and the inner label. These features can be seen in the variances in the application of the label to these two distinct types of bags can be seen in FIGS. 7 through 12. FIGS. 7 and 8 show cross-sectional views of the resealable label as applied to bag walls while the label is sealed, while FIGS. 9 and 10 show those same labels and bag walls when the label has been opened. Exploded views of the resealable label as applied to these types of bags are seen in FIGS. 11 and 12.

FIG. 7 shows the cross-sectional view along line A-A of FIG. 2, where both a resealable label 100 and an inner label 200 have been adhered to a panel 302 of a bag wall. In this embodiment, a portion of the bag wall 302 has been removed to permit the resealable label 100 and the inner label 202 to adhere to one another. The resealable label 100 includes both a top layer 102 and an inner layer 104. Regions of adhesive 108 and deadener 110 can be seen, relative to the perforation 106 of the bottom layer of the label. The inner label 200 has been adhered to the inside of the bag wall 302 and the resealable label 100 via an adhesive layer 204 on the inner label.

As previously discussed, the perforations of the resealable label 106 and the inner label 202 should be complementary in shape, though not necessarily in the same dimensions. This is illustrated in FIG. 7, where the gap between these two perforations forms a reclosure region 132. This same region can be seen in FIG. 1. In this way, the two labels 100, 200 form an adhesive label-to-label seal around the bag wall 302. Among other applications, this mechanism is suitable for use in multi-layered paper bags, where the contents of the bag might cause degradation of the bag wall material through repeated passage of the bag contents, which could be greasy foodstuffs.

FIG. 8 shows the cross-sectional view along line A-A of FIG. 2, where a resealable label 100 has been adhered to a panel of a bag wall 302 in the absence of an inner label, where the bag wall has merely been perforated in a shape complementary to the perforation of the resealable label. This application is distinct from that of FIG. 7, where a hole was made in the bag wall.

In this embodiment, both the top layer 102 and the bottom layer 104 of the resealable label can be seen, as well as the regions of adhesive 108 and adhesive 110 between the layers. An additional layer of adhesive has adhered the label 100 to the bag wall 302. The perforation 106 of the bottom layer 104 can be seen in relation to a perforation on the panel of the bag, where the gap between these two labels form a reclosure region 132.

FIG. 9 shows the cross-sectional view along line B-B of FIG. 1, where both a resealable label 100 and an inner label 200 have been adhered to a panel of a bag wall 302. In this way, FIG. 9 is an opened view of the arrangement seen in FIG. 7.

In this embodiment, where the resealable label 100 includes both a top layer 102 and a bottom layer 104, the label has been opened in an opening direction 400. When opened, the entire top layer 102 above the line (as seen in FIG. 3, for example, and as defined by the endpoints of the perforation of the bottom layer) may be pulled back in the opening direction 400 away from the bag wall 302. With the top layer of the label 102, also pulled back is a portion of the bottom layer 104, this portion bound by the concave region of the perforation above the line, as well as a portion of the inner label 200, this portion bound by the concave region of the perforation above the line. Adhesive 108 on the underside of the top layer 102 permits the re-openable reattachment of the top layer to the bottom layer 104, with the aid of the deadener 110. The region of deadener 206 of the inner label permits the re-openable reattachment of the bottom layer 104 to the inner label 200 in the reclosure region 132.

FIG. 10 shows the cross-sectional view along line B-B of FIG. 1, where a resealable label 100 has been adhered to a panel of a bag wall 302. In this way, FIG. 10 is an opened view of the arrangement seen in FIG. 8.

In this embodiment, where the resealable label 100 includes both a top layer 102 and a bottom layer 104, the label has been opened in an opening direction 400. When opened, the entire top layer 102 above the line (as seen in FIG. 3, for example, and as defined by the endpoints of the perforation of the bottom layer) may be pulled back in the opening direction 400 away from the bag wall 302. With the top layer of the label 102, also pulled back is a portion of the bottom layer 104, this portion bound by the concave region of the perforation above the line, as well as a portion of the bag wall 302. In this embodiment, no inner label is present, and the bag wall has been die cut or otherwise perforated. The perforation of the bag wall should be complementary in shape, though not necessarily in the same dimensions, to the perforation of the bottom layer of the resealable label, as can be further seen in subsequent figures.

FIG. 11 shows an exploded perspective view of an embodiment of a resealable label 100 and its layers 102, 104 as applied to the exterior of a panel 302 of a bag wall that has been perforated with a tombstone-shaped cut 304. FIG. 11 demonstrates an exploded view of the arrangement represented in the cross-sectional views of FIGS. 8 and 10, where no inner label is present. As previously discussed, the perforations 106, 304 of the bottom layer and the panel of the bag are complementary in shape. In this embodiment, both are U-shaped. However, in order to achieve the reclosure region 132 as seen in FIG. 8, the perforation 304 of the bag panel should be slightly smaller than the perforation 106 of the bottom layer.

Thus when the label is adhered to the surface of a bag via the adhesive on the bottom layer of the label, the bag wall perforation, which is complementary in shape to the perforation of the bottom layer of the label, is framed by the perforation of the bottom layer of the label. In this way, the line of the bottom layer of the label should align with a similar line formed by the endpoints of the perforation on the bag wall. This framing and alignment creates the desired reclosure region.

FIG. 12 shows an exploded perspective view of an embodiment of a resealable label 100 and an inner label 200 as applied to the exterior of a panel of a bag wall 302 that has been perforated with a tombstone-shaped hole 306. The top layer 102 and bottom layer 104 are both rounded squares that adhere to one another via the adhesive 108 and deadener 110 arrangement seen in prior figures. Similarly, the inner label 200 adheres to both the panel of the bag 302, as well as the bottom layer 104 of the resealable label 100 through the hole 306 on the panel of the bag. Though the perforations 106, 202 of the bottom layer of the resealable label and the inner label are complementary in shape, in order to achieve the reclosure region 132 as seen in FIG. 7, the perforation 202 of the inner label should be slightly smaller than the perforation 106 of the bottom layer. Additionally, in order to create an adhesive seal around the edges of the die cut hole 306 on the bag wall 302, that die cut hole should be larger than both the perforation 202 of the inner label and the perforation 106 of the bottom layer, as can be seen in FIGS. 7 and 9.

Thus a resalable label, acting as an outer label, and an inner label may both adhered to a bag wall to create a resealable label system. In this system, the bag wall has an interior side and an exterior side, and the bag wall has a hole complementary in shape to a perimeter formed by the perforation of the bottom layer of the outer label and the line between the endpoints of the perforation of the bottom layer. The hole has edges and is larger than the perimeter. In this system, the outer label is adhered to the exterior side of the bag wall via the adhesive on the bottom layer of the outer label, and the inner label is adhered to the interior side of the bag wall via the adhesive layer on the inner label. To align the labels and hole in the bag wall, the outer label and inner label are mounted on the bag wall such that the perforation of the inner label is framed by the perforation of the bottom layer of the label to create a reclosure region on the inner label, and the outer label and inner label are positioned on the bag wall hole such that the labels adhere to each other to create a label-to-label seal that encloses the edges of the hole. This is seen, for example, in FIG. 7.

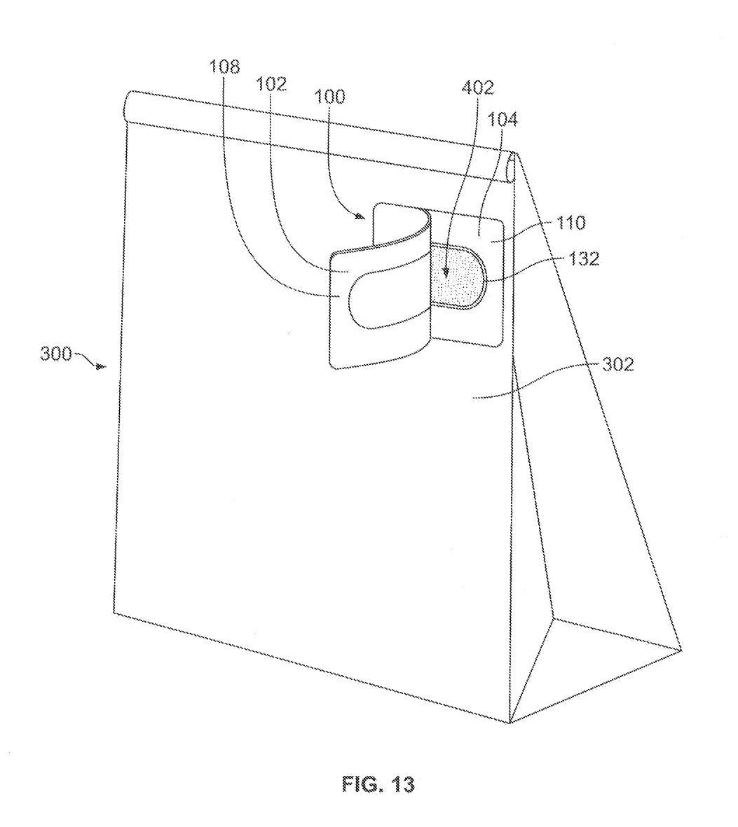

FIG. 13 shows an embodiment of a resealable label 100 adhered to panel 302 of a gusseted top-sealed bag 300, the label pulled back in an open position to grant access to the inside of the bag 402.

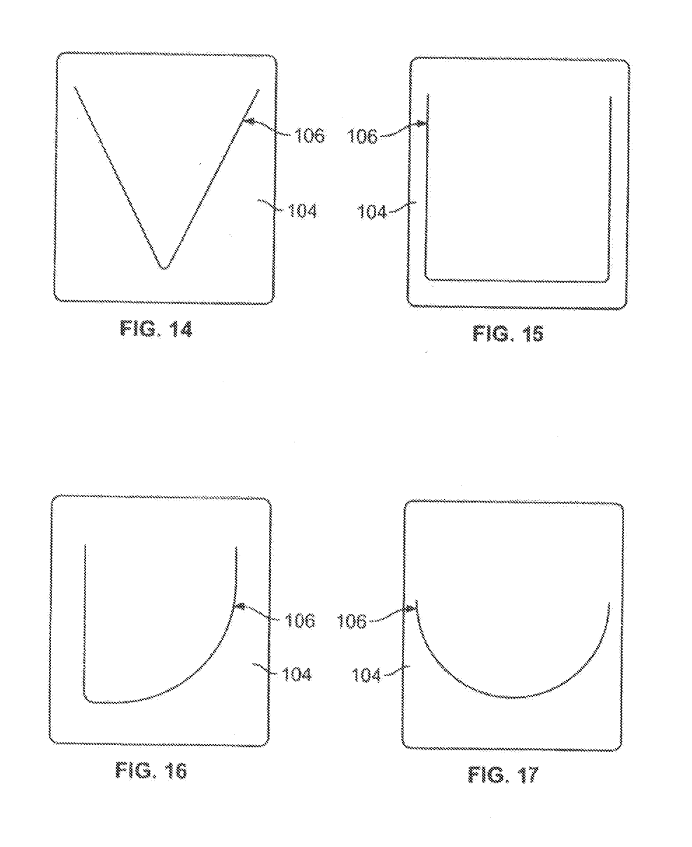

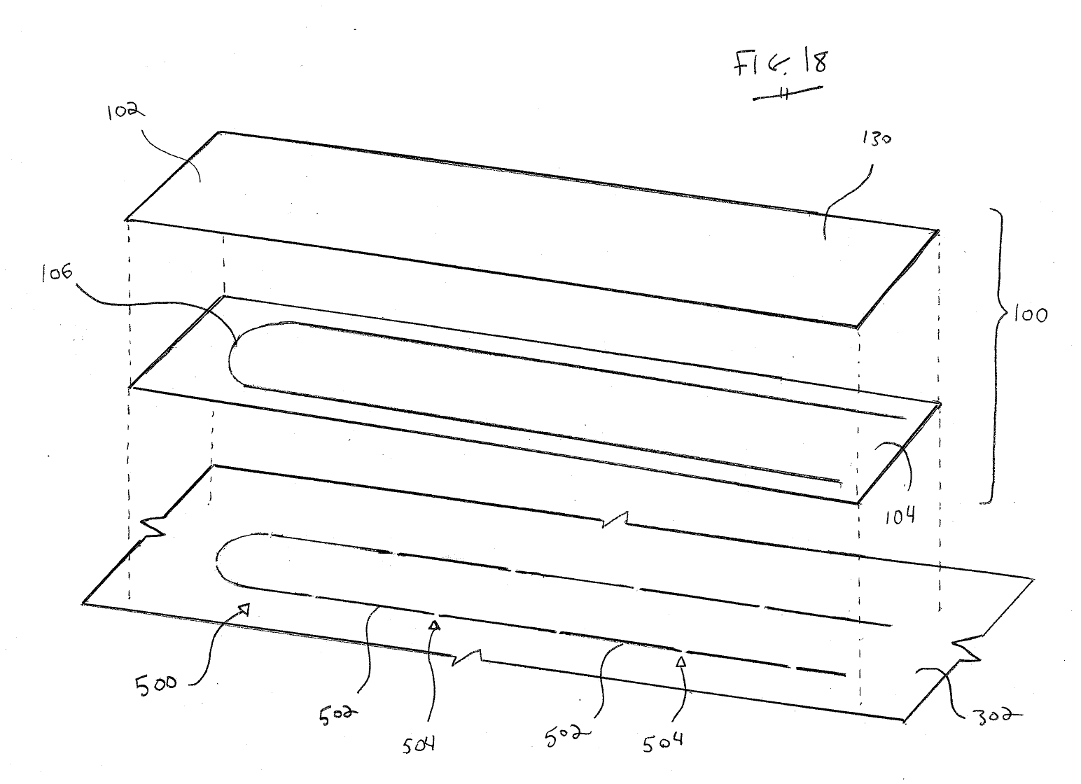

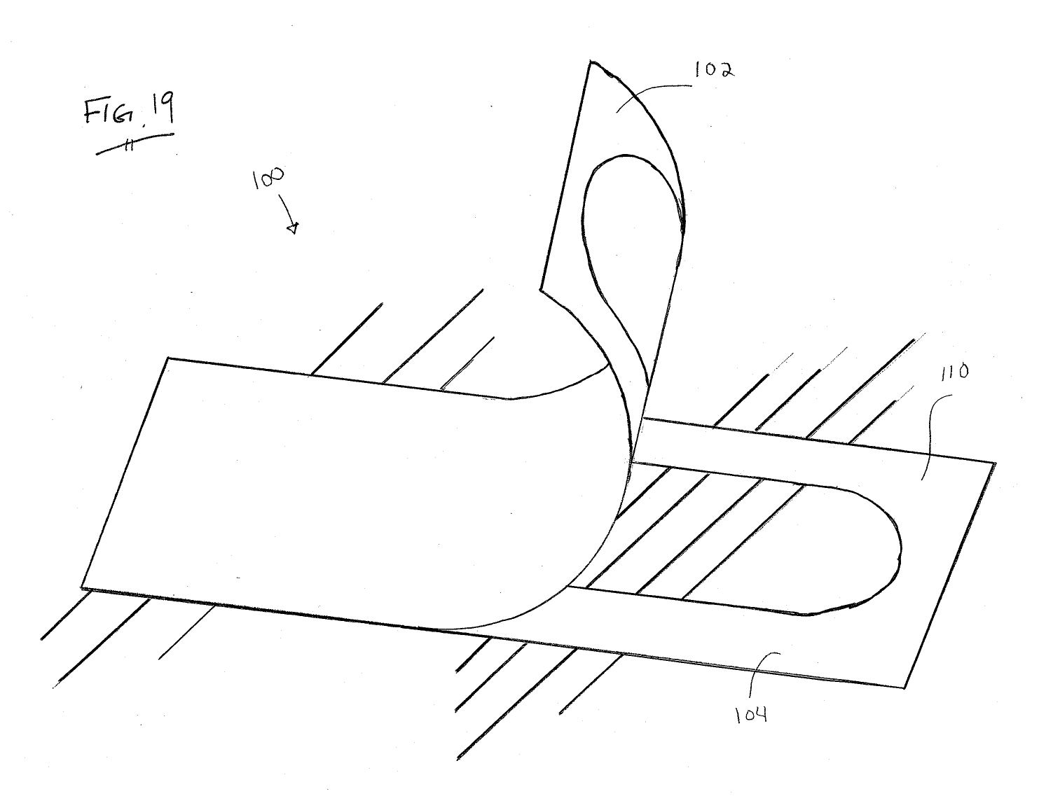

FIG. 14 shows an embodiment of the shape of the concave perforation 106 of the resealable label, this shape being a V having a rounded bottom. FIG. 15 shows another embodiment of the shape of the concave perforation of the resealable label, this shape being a rectangle having rounded corners. FIG. 16 shows yet another embodiment of the shape of the concave portion of the resealable label. FIG. 17 shows another embodiment of the shape of the concave portion of the resealable label, this shape being a semicircle. The various embodiments of FIGS. 14 through 17 and all others are embraced within the scope of this disclosure.

In certain instances, it may be desirable to have an elongated label 100 and corresponding perforation 304 on the bag wall 302. For example, the contents of some bags may be light enough and the bags themselves may be manageable enough that picking up the bag and pouring the contents out of the bag 300 when the label is applied thereto and in the open position is practical. In other instances, it may not be practical, for example when a large bag of heavy contents is at issue, such as a bag of dog food weighing thirty to fifty pounds. In that instance, it may be preferred by the consumer to have a label and corresponding opening on the bag large enough that the consumer may simply reach into the bag while it rests on the ground and scoop out the contents from the bag, which may then be resealed via the label of the disclosure.

While the somewhat rounded square shape of the labels seen in FIGS. 1 through 6, for example, are not intended to be so limiting in dimension, an embodiment where the label is longer than the wide will now be discussed. In such an instance, for example, the label may be up to as long as the width of the panel of the bag onto which it will be mounted.

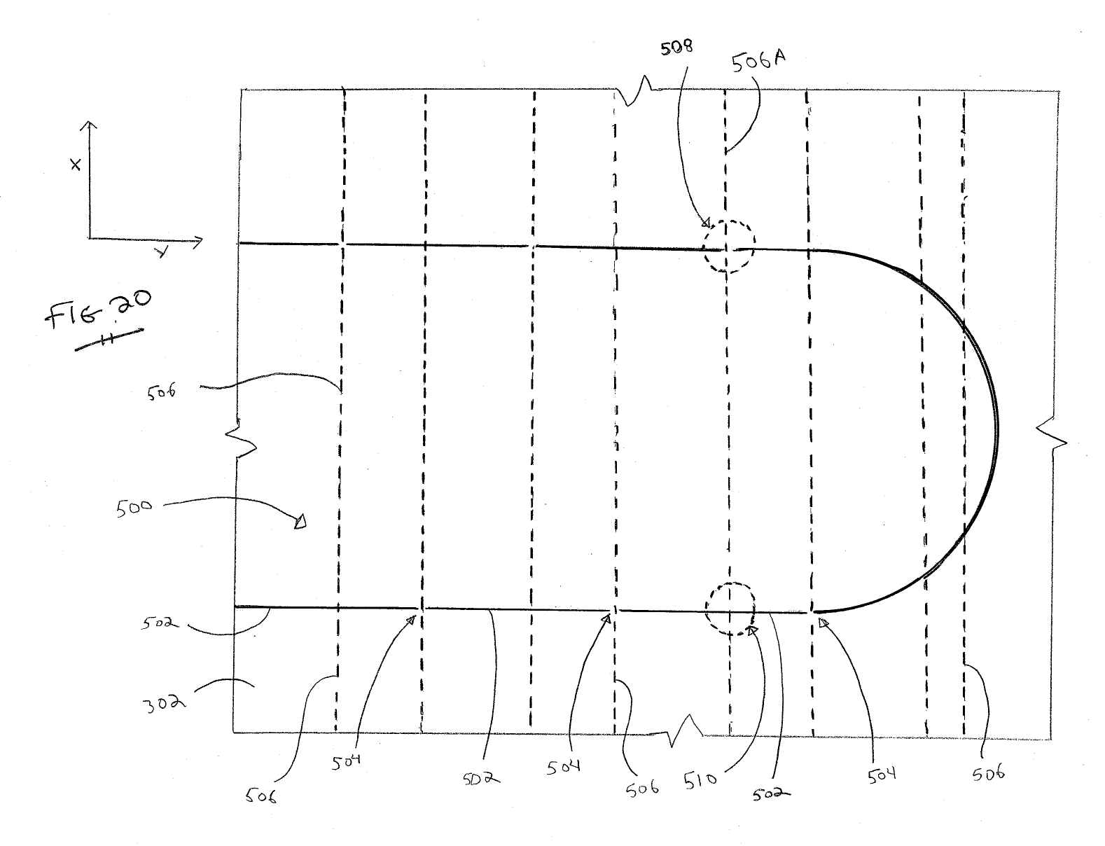

FIG. 18 shows an exploded perspective view of an embodiment of a resealable label and its layers as applied to the exterior of a portion of a panel of a bag wall. Specifically, FIG. 18 shows a resealable label 100 and its layers 102, 104 as applied to the exterior of a panel 302 of a bag wall that has been perforated with a series 500 of perforations 502 that are separated by small uncut segments 504. This series 500 is in an elongated tombstone shape that is complementary in shape to the perforation 106 of the bottom layer 104. Similar to as previously discussed for the complementary perforations 106 and 304, here the series 500 of perforations 502 on the bag wall 302 and the perforation 106 of the bottom layer 104 of the label are also complementary in shape. In this embodiment, both are elongated U-shaped. However, in order to achieve the reclosure region 132 as seen in FIG. 8, the series 500 of perforations 502 of the bag panel 302 should also be slightly smaller than the perforation 106 of the bottom layer. FIG. 19 shows an embodiment of the label 100 of FIG. 18, assembled and at least partially opened, though not mounted on a bag wall panel.

The series 500 of perforations 502 on the bag wall 302 are present as an alternative or additional tamper-evident feature for use with a label of the disclosure, distinct from the optional tamper evident apparatus 120 seen in other figures, though they may be used in concert to provide the consumer with at least two indications that the package has not been tampered with. As the consumer for the first time pulls back on the label 100 to reveal the contents of the bag, the individual uncut segments 504 will break from the force of the opening of the label. This may create any number of sensory experiences for the consumer, including the auditory snapping of the uncut portions, the physical sensation of breaking each of these uncut portions, and/or the visual of small remnants of the uncut portions that have been snapped apart with respect to the adjacent perforations. When a single label 100 is adhered to a bag wall 302, this bag wall tamper-evident feature 500 may optionally be employed.

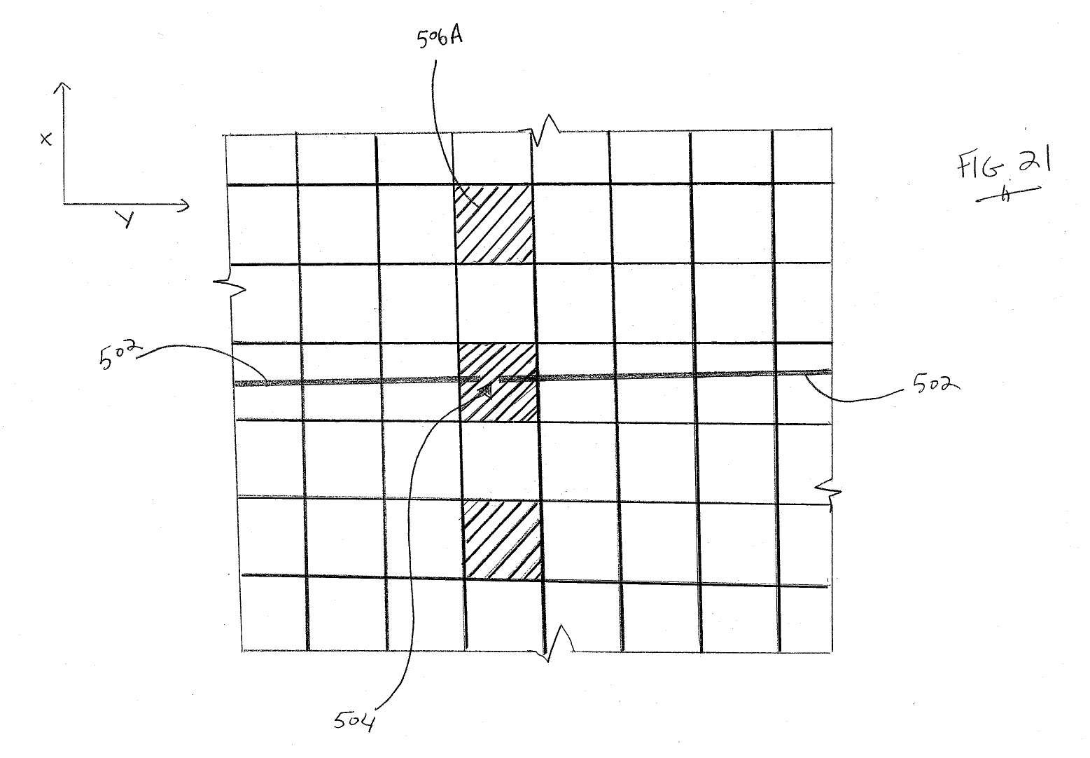

FIG. 20 details an improvement over the art that overcomes a particular challenge that may come with a certain type of bag construction. Many dog food bags are now constructed of a multi-layered assembly of an interior layer of woven oriented polypropylene (OPP) co-laminated to a reverse-printed oriented polypropylene outer layer. Woven oriented polypropylene is becoming more popular for bags that are full of heavy, bulky contents, such as dry dog food, due to the material's strength and puncture-resistance. Tearing a strand of woven OPP perpendicular to its length is quite difficult. When a large bag is manufactured from this construction, it is common for the woven OPP strands to run horizontally and vertically, relative to the ground, when the finished and filled bag is sitting upright, as it would when a consumer opens the bag to access the contents. The series of perforations placed on the bag wall may take into account these OPP strands running generally left-and-right and up-and-down along the interior structure of a bag, as seen in FIG. 20.

Turning to FIG. 20, an embodiment of a portion of the perforation on the bag wall is shown, with details on the relative positions of various elements of a bag wall tamper-evident feature. The series 500 of perforations 502 are interrupted by uncut segments 504 of bag wall. In this embodiment, the label has been applied to a bag horizontally, such that the bag sits upright on the ground, represented by the Y axis, and the longer portion of the label runs parallel thereto, also along the Y axis. In this embodiment, the woven OPP strands run generally in the X and Y directions. Select strands 506 of woven OPP are shown by dashed lines in FIG. 20, though it would be understood by one of skill in the art that these strands 506 are not the only vertical OPP strands. A typical woven OPP layer is a continuous tight weave, with no intended gaps.

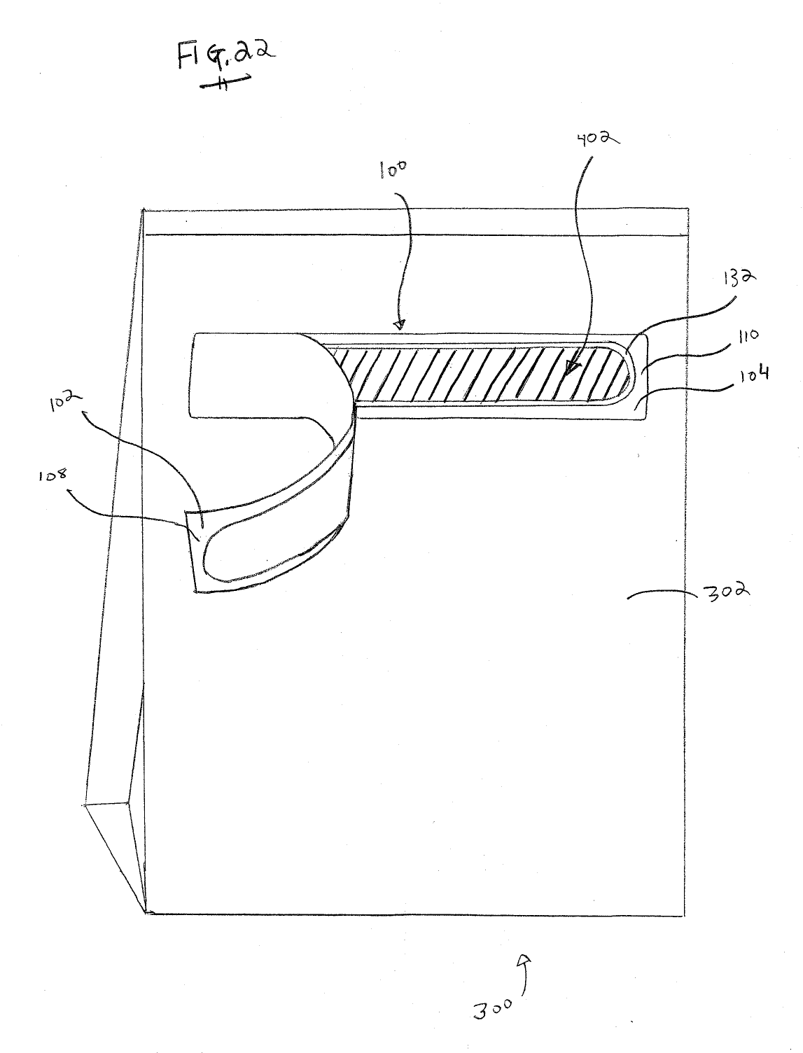

Referring in particular to woven OPP strand 506A, as an example, a portion of this strand at least partially passes vertically through an uncut segment as seen in highlighted area 508 but is cut completely as it passes through a perforation 502 as seen in highlighted area 510. The width of each strand of woven OPP in this embodiment will be understood to be at least slightly wider than the width of the uncut segment 504 such that the perforations 502 do actually at least partially cut each strand of woven OPP. This will allow the consumer to open the label and the bag and tear through the strong material that are strands of tightly-woven OPP with no gaps between the individual strands. This can be seen in FIG. 21, which is an embodiment showing interior detail of highlighted area 508, showing a portion of woven OPP. Here, woven OPP strand 506A is designated by hash-marked areas, and partially passes through an uncut segment 504. The strand 506A is partially cut by one or more perforations 502, which will make the strand breakable by perpendicular tearing when the label is opened along the Y axis.

The reason for the offset, staggered configurations of the uncut segments 504 along the Y axis seen in FIGS. 20 and 21 is to prevent any one strand 506 of woven OPP to pass vertically through two uncut segments on opposite sides of the series 500. In this way, the opening of the label is made easier for the consumer than if the uncut segments were aligned vertically. This embodiment in FIGS. 20 and 21 are not intended to be limiting, and any configuration of uncut segments 504 along the series 500 of perforations 502 may be employed that permits the opening of the label and the bag as per this disclosure. Where the composition of the bag onto which the single label is applied and the bag wall tamper-evident feature is being used does not include a woven OPP layer, the staggering of the uncut segments 504 may not be necessary.

FIG. 22 shows an embodiment of a resealable label 100 of FIG. 18 adhered to panel 302 of a gusseted top-sealed bag 300, the label pulled back in an open position to grant access to the inside of the bag 402. The size of the opening of the label and bag in this configuration, as compared to that in FIG. 13, for example, may be more amenable to reaching into the bag and scooping out contents than to picking up the bag and pouring.

The perforating of the bag wall 302 for the embodiment seen in FIGS. 18 through 22 can be achieved in a variety of methods known in the art, including through a die cutting of the bag wall. In a die cutting, there may be two complementary die cutting blades on either side of the bag wall in the manufacturing process that meet and cut the bag selectively to create a series 500 of perforations 502 while leaving a series of uncut segments 504. In another embodiment, a rotary die cut could be used as the bags move down the assembly line during the manufacturing process.

The length of the perforations may vary from one application to another, which will increase or decrease the number of uncut segments in each series. In an embodiment, the perforations in a single series may vary and be non-uniform in length. In some constructions, such as for example those where no woven OPP is used, the length of the uncut segments may be longer.

The adhesion strength of the adhesive holding the label to the bag wall should be sufficiently greater than the force required to break the uncut segments when opening the label to access the contents of the bag, or else the portion of the bag within the concave region defined by the series of perforations might separate from the corresponding concave portion of the bottom layer of the label. This is another instance where staggering the uncut segments horizontally as discussed previously, such that the consumer opening the label would only have to break one uncut segment at a time during the peeling open action of opening the label and bag.

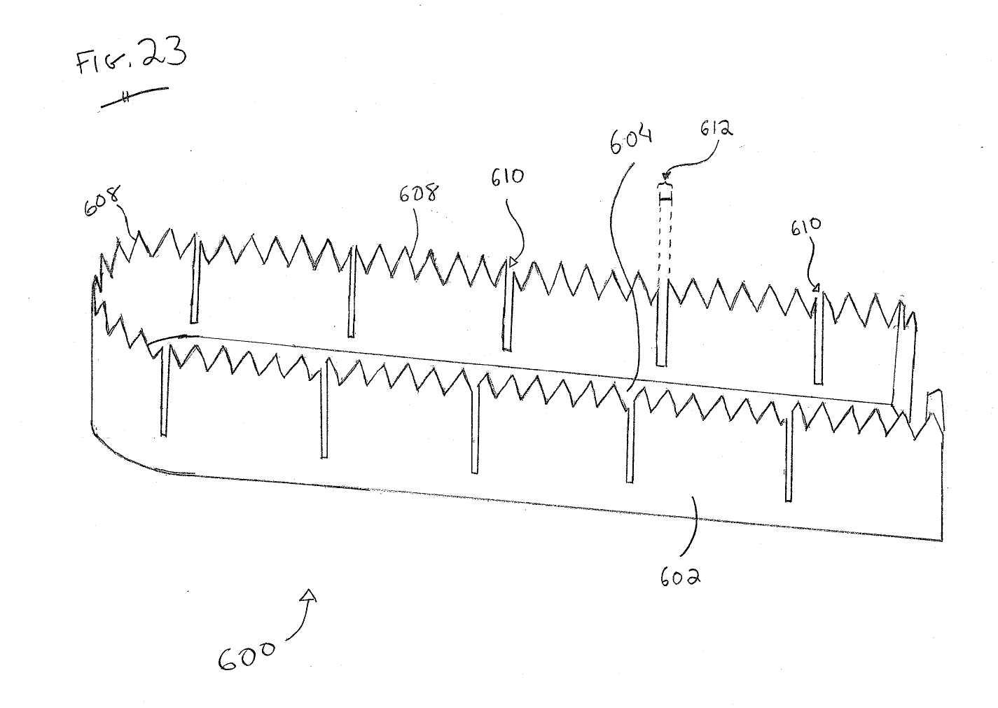

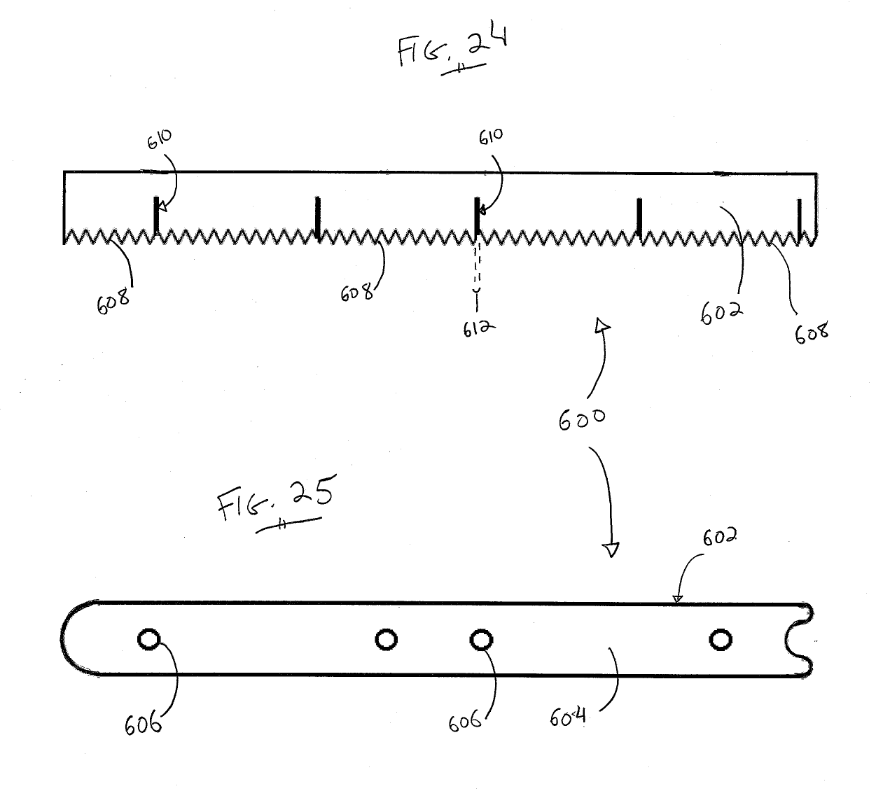

In order to create the series 500 of perforations 502 on the bag wall 302, a cutting die 600 may be used. Though one of skill in the art may create the series 500 of perforations 502 in a number of ways, an elevated perspective view of an embodiment of a cutting die 600 is seen in FIG. 23. Additional views of this embodiment of the cutting die 600 can be seen in FIGS. 24 and 25, which show side and top down views, respectively. In this embodiment, the cutting die 600 may comprise a strip of metal 602 of a generally consistent width bent by its length around and attached to a bracket 604, where the bracket includes one or more mounting holes 606 for mounting the die 600 to a piece of machinery that will perform the die cutting of the bag to create the series of perforations thereon. As seen in the embodiment shown in FIG. 23, one side of the length of the strip of metal may include a series of teeth 608 to aid in the rapid cutting of the bag wall. These teeth may be, for example, generally triangular and substantially uniform along the length of the strip of metal 602. This toothed cutting structure may be advantageous to a single, flush cutting surface on the length of the strip of metal when rapid sequential cutting on bag machinery is desired. The angles of the teeth may be optimized by the bag manufacturer in any given application, where sharper, pointier teeth may be needed in more puncture-resistant bag material.

FIGS. 23 through 25 further show gaps 610 on the strip of metal 602 on the cutting die 600. These gaps 610 enable the creation of the uncut segments 504 as seen in FIGS. 18, 20, and 21. While the teeth 608 portions of the cutting die 600 create the perforations 502 on the bag wall during the mechanical die cutting process, the gaps 610 on the cutting die 600 create the uncut segments 504, which together are what create the series 500 of perforations instead of a single continuous perforation 304, as can be seen by comparison in FIG. 11. The width 612 of the gaps on the cutting die may be consistent throughout each cutting die. Additionally, the widths 612 of the gaps may vary from one cutting die to another in accordance with the width of the average thread in the woven OPP to achieve the at least partial cutting seen in FIG. 21, for example. Further, the number of gaps on a given die may vary from one application to another, where more gaps will make a package have more uncut segments, which may make the package harder to open or provide the consumer with more physical and auditory indications that a tamper-evident feature is being breached. These and other adjustments made by the manufacturer are embraced by this disclosure, and this specific cutting die is not intended to be limiting. Where a non-woven plastic film or other layered bag material is used, the gaps, and thus the uncut segments, may be larger because no strands of OPP are being torn by a consumer in opening the label.

Although an elongated tombstone shape is seen in the figures, other suitable shapes are embraced for the series 500 of perforations 502. In an embodiment, the shape of the series includes two substantially parallel lengths joined at adjacent ends to form a non-linear shape having both a concave region between the two substantially parallel lengths. In an embodiment, the label is mounted on a bag such that, when the bag is resting on its bottom on a surface, the label is generally oriented in the vertical or horizontal direction relative to the surface, and the gaps in the series of perforations has been staggered as seen in the figures. Thus in this shape, having applied the die cutting pattern seen in the figures, the segments of uncut bag material on one parallel length of the series may be staggered relative to those on the other parallel length of the series.

The cutting die 600 may be mounted to a machine in-line with a full bag manufacturing process, such that, for example, a roll printed bag panel material that includes a layer of woven OPP may be stamped with the cutting die at predetermined spaces as a part of the process. This may be achieved, for example, before the panel of material has been folded into a bag or tube shape, or at any other suitable time in the manufacturing process. The cutting die may be attached to, for example, a reciprocating arm on the manufacturing line so as to rapidly cut the material to create the series 500 of perforations 502. When on the line, the manufacturer may choose to have two complementary mirror image cutting dies on either side of the material to effectively together bite through the material to create the series of perforations. Alternatively, one cutting die may be used, for example in conjunction with an anvil on the other side of the material. In another embodiment, one or a series of cutting dies may be attached to a rotary die cutting unit in-line to create the perforations on the material as bag material is fed through the machinery and past the rotating die or dies. These methods of cutting and others known in the art are all embraced by the disclosure, to the extent that any such methods would result in the series of perforations as disclosed herein or equivalents thereof.

In a non-limiting embodiment of a manufacturing process, a roll of printed bag material that is made of a layer of reverse-oriented printed polypropylene co-laminated to a layer of woven oriented polypropylene is unrolled and fed into a bag manufacturing machine by its length. This unrolled portion of bag material may then be perforated by a cutting die at predetermined intervals corresponding to the printing thereon, such that the eventual bags formed from the bag material will each have substantially uniformly positioned series of perforations on the bags, giving a consistency across the bags to the eyes of the consumer. These perforated bag segments may then be formed into bags via various bag manufacturing processes and stations on the machinery, wherein a reclosable label is applied thereto before, during, or after the bag manufacturing process. The result is a fillable, raw bag having a reclosable label thereon that is aligned with a series of perforations to create a bag tamper evident feature.

The top layer of the resealable label may itself be constructed of multiple layers. In an embodiment, the top layer includes a clear outer film ply adhered to a middle film ply. In this way, the clear ply may provide reinforcing strength to the label while providing a clear view of any printing that may be on the middle ply. As used herein, a middle ply refers to one or more ply of the resealable label between a clear outer ply and the bottom layer, where the middle ply and the outer ply make up the top layer.

In an embodiment, the outer film ply is a clear plastic film layer. The outer film ply may be, for example clear oriented polypropylene. In an embodiment, the middle ply is a white plastic film, for example white oriented polypropylene. The plastic film may include printing and/or be of any suitable color.

The bottom layer may also be constructed of multiple layers, analogous to the top layer. In an embodiment, the bottom layer is a single ply white oriented polypropylene, though any suitable film or layering of films may be used for the bottom layer.

When the resealable label is applied to plastic bags, such that no inner label is used in conjunction with the resealable label, the wall of the plastic bag may be die cut or otherwise perforated to create a perforation complementary to that of the resealable label. The resealable label may be applied to plastic bags in an in-line manufacturing process, either as a step during or subsequent to the construction of the plastic bags. The application of the resealable label should take care to line up the perforation of the bottom layer with the perforation on the panel of the bag to create the reclosure region seen in the Figures.

Where the resealable label is applied to paper bags, including multi-wall paper bags, an inner label may be used in conjunction with the resealable label, and the wall of the bag may be die cut or otherwise perforated to create a hole through the bag wall. The resealable label may be applied to paper bags in an in-line manufacturing process, either as a step during or subsequent to the construction of the paper bags. The application of the resealable label should take care to line up the perforation of the bottom layer with the perforation of the inner label to create the reclosure region seen in the Figures, and to seal off the cut edges of the hole on the bag panel via an adhesive seal between the inner label and the resealable label.

The inner label may be constructed of one or more ply. In an embodiment, the label may be a single ply clear oriented polypropylene film layer. Where applications call for the contents of the bag to be foodstuffs, it may be desirable for the inner label to be constructed of FDA compliant materials suitable for direct food contact.

In any application, where it is desirable for printing on the panel of the bag to remain visible even in the presence of a resealable label, each layer and ply of the resealable label may be clear. This may be achieved in a variety of ways known in the art, including the construction of the resealable label via clear oriented polypropylene and a clear adhesive.

Thus the disclosure includes a resealable label including a top layer and a bottom layer. The label has edges that define a shape of the label. The top layer is at least one ply the bottom layer is at least one ply. The top layer is adhered to the bottom layer via an adhesive layer there-between. The bottom layer further includes a perforation having two endpoints, where the perforation is non-linear and includes both a concave side and a convex side. The label further includes a line defined by the endpoints of the perforation, the line extending beyond the endpoints and terminating at edges of the label. The label further includes a layer of deadener between the layers, the deadener being on the convex side of the perforation, and terminating at the line, where the deadener is at least some distance away from the perforation such that the deadener and the perforation do not abut. The label may further include a layer of adhesive on the bottom layer for adhering the label to a surface. In this way, the aforementioned layer of adhesive on the bottom layer is not between any layers of the label, but rather on the outermost side of the bottom layer to enable the label to be adhered to a surface.

A method of manufacturing a resealable bag is also disclosed. This method includes the steps of providing a resealable label, the label comprising a top layer and a bottom layer, the label having edges that define a shape of the label, where the top layer is at least one ply, and where the bottom layer is at least one ply, and the top layer is adhered to the bottom layer via an adhesive layer there-between, wherein the bottom layer further comprises a perforation having two endpoints, where the perforation is non-linear and includes both a concave side and a convex side, the label further comprising a line defined by the endpoints of the perforation, the line extending beyond the endpoints and terminating at edges of the label, the label further comprising a layer of deadener between the layers, the deadener being on the convex side of the perforation, and terminating at the line, where the deadener is at least some distance away from the perforation such that the deadener and the perforation do not abut. Additional steps to the method include providing a panel of bag material, perforating the panel of bag material to create a series of perforations and gaps there-between of uncut bag material, and adhering the label to the panel of bag material such that the perforation of the bag material is framed by the perforation of the bottom layer of the label to create a reclosure region on the bag material. This method may also include a panel of bag material comprising at least one layer of woven plastic. In another embodiment, the method includes a label with layer of adhesive on the bottom layer for adhering the label to the bag material. The bag material may be at least one layer of woven oriented polypropylene (OPP) co-laminated to a layer of reverse-printed oriented polypropylene, and optionally the label in the method may be adhered to the reverse-printed oriented polypropylene layer of the bag material.

In the disclosed method, the perforating the panel of bag material may be achieved via the application of a cutting die to the panel. In an embodiment, the cutting die includes a strip of metal having been bent by its length to a shape complementary to the shape of the perforation of the bottom layer of the label, the shape of the strip of metal being smaller than the perforation of the bottom layer of the label. The strip of metal may have a series of teeth on one side of the length of the strip, and may also have a series of gaps along its length, the gaps having widths and defining gaps between series of teeth.

In another embodiment of the disclosed method, the cutting die includes a strip of metal bent by its length around and attached to a bracket, wherein one side of the length of the strip of metal comprises a series of teeth and a series of gaps. Optionally in this method, the bracket can include one or more mounting holes for mounting the die to machinery to perform the perforating. The shape of the bent strip of metal may be complementary to the shape of the perforation of the bottom layer of the label, the shape of the strip of metal being smaller than the perforation of the bottom layer of the label.

For the purposes of this disclosure, non-linear is intended to mean any line that is not a straight line.

Any number or combination of gauge and thickness of films may be used to construct the resealable label and/or inner label.

When used in combination with an inner label, the resealable label of the disclosure may be referred to, for example, as the outer label.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention as well as all equivalents thereof.

We claim:

1. A method of assembling a resealable label onto a panel of bag material comprising the steps of
providing a resealable label, the label comprising a top layer and a bottom layer, the label having edges that define a shape of the label, where the top layer is at least one ply, and where the bottom layer is at least one ply, and the top layer is adhered to the bottom layer via an adhesive layer there-between, wherein the bottom layer further comprises a perforation having two endpoints, where the perforation is non-linear and includes both a concave side and a convex side, the label further comprising a line defined by the endpoints of the perforation, the line extending beyond the endpoints and terminating at edges of the label, the label further comprising a layer of deadener between the layers, the deadener being on the convex side of the perforation, and terminating at the line, where the deadener is at least some distance away from the perforation such that the deadener and the perforation do not abut,
providing a panel of bag material,
perforating the panel of bag material to create a series of perforations and gaps there-between of uncut bag material,
adhering the bottom layer of the label to the panel of bag material such that the perforation of the bag material is framed by the perforation of the bottom layer of the label to create a reclosure region on the bag material.

2. The method of claim 1, wherein the panel of bag material comprising at least one layer of woven plastic.

3. The method of claim 1, further comprising a layer of adhesive on the bottom layer for adhering the label to the bag material.

4. The method of claim 2, wherein the bag material comprises a layer of woven oriented polypropylene (OPP) co-laminated to a layer of reverse-printed oriented polypropylene.

5. The method of claim 4, wherein the label is adhered to the reverse-printed oriented polypropylene layer of the bag material.

6. The method of claim 1, wherein the perforating the panel of bag material is achieved via the application of a cutting die to the panel.

7. The method of claim 6, wherein the cutting die comprises a strip of metal having been bent by its length to a shape complementary to the shape of the perforation of the bottom layer of the label, the shape of the strip of metal being smaller than the perforation of the bottom layer of the label.

8. The method of claim 7, wherein the strip of metal comprises a series of teeth on one side of the length of the strip.

9. The method of claim 8, wherein the strip of metal further comprises a series of gaps along its length, the gaps having widths and defining gaps between series of teeth.

10. The method of claim 6, wherein the cutting die comprises a strip of metal bent by its length around and attached to a bracket, wherein one side of the length of the strip of metal comprises a series of teeth and a series of gaps.

11. The method of claim 10, wherein the shape of the bent strip of metal is complementary to the shape of the perforation of the bottom layer of the label, the shape of the strip of metal being smaller than the perforation of the bottom layer of the label.

12. The method of claim 6, wherein the application of the cutting die to the panel is through a mechanical process selected from the group consisting of cutting via reciprocating blade and rotary die cutting.

13. The method of claim 1, where in the series of perforations and gaps there-between of uncut bag material comprise a shape, wherein the shape includes two substantially parallel lengths joined at adjacent ends to form a non-linear shape having both a concave region between the two substantially parallel lengths.

14. The method of claim 13, wherein the shape is an elongated tombstone.

15. A method of assembling a resealable label onto a panel of bag material comprising the steps of
providing a resealable label, the label comprising a top layer and a bottom layer,
providing a panel of bag material, the panel of bag material comprising at least one layer of woven plastic,
perforating the panel of bag material to create a series of perforations and gaps there-between of segments of uncut bag material, wherein the series of perforations and segments of uncut bag material there-between comprise a shape, wherein the shape includes two substantially parallel lengths joined at adjacent ends to form a non-linear shape having both a concave region between the two substantially parallel lengths, wherein the segments of uncut bag material on one parallel length of the series are staggered relative to those on the other parallel length of the series,
adhering the bottom layer of the label to the panel of bag material such that the opening of the label for the first time causes the breaking of the segments of uncut bag material.

16. The method of claim 15, wherein the bag material comprises a layer of woven oriented polypropylene (OPP) co-laminated to a layer of plastic film.

17. The method of claim 15, wherein the perforating the panel of bag material is achieved via the application of a cutting die to the panel, wherein the cutting die comprises a strip of metal having been bent by its length to form the shape, the strip of metal comprising a series of teeth on one side of the length of the strip, and a series of gaps along its length, the gaps having widths and defining gaps between series of teeth.

18. A method of assembling a resealable label onto a panel of bag material comprising the steps of
providing a resealable label, the label comprising a top layer and a bottom layer,
providing a spool of bag material, the panel of bag material having an indefinite length and comprising at least one layer of woven plastic,
presenting the bag material to a bag manufacturing machine by feeding a continuous length of the bag material by its length from the spool to the machine,
repeatedly perforating the continuous length of bag material on the bag manufacturing machine at predetermined intervals down the length of the bag material to create repeated series of perforations having gaps there-between of segments of uncut bag material,
forming the continuous length of bag material into individual fillable bags via a bag manufacturing process on the bag manufacturing machine, each individual fillable bag having series of perforations and segments of uncut bag material there-between,
adhering the bottom layer of the label to the panel of bag material in alignment with the series of perforations and segments of uncut bag material there-between such that the opening of the label for the first time causes the breaking of the segments of uncut bag material.

19. The method of claim 18, wherein the roll of printed bag material comprises a layer of woven oriented polypropylene (OPP) co-laminated to a layer of plastic film.

20. The method of claim 18, where in the resealable label comprises a top layer and a bottom layer, the label having edges that define a shape of the label, where the top layer is at least one ply, and where the bottom layer is at least one ply, and the top layer is adhered to the bottom layer via an adhesive layer there-between, wherein the bottom layer further comprises a perforation having two endpoints, where the perforation is non-linear and includes both a concave side and a convex side, the label further comprising a line defined by the endpoints of the perforation, the line extending beyond the endpoints and terminating at edges of the label, the label further comprising a layer of deadener between the layers, the deadener being on the convex side of the perforation, and terminating at the line, where the deadener is at least some distance away from the perforation such that the deadener and the perforation do not abut.
